(19) United States
(12) Patent Application Publication
(10) Pub. No.: US 2009/0037950 A1
(43) Pub. Date: Feb. 5, 2009

(54) SYSTEM FOR PROVIDING TUNABLE PARAMETERS TO CONTROL DISTRIBUTION IN A DIGITAL MEDIA DISTRIBUTOR

(75) Inventors: Jennie Ching, Northridge, CA (US); Eric Hsiao, San Marino, CA (US); Peter S. Lee, Calabasas, CA (US)

Correspondence Address: IBM ST-SVL;SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 12/185,049

(22) Filed: Aug. 1, 2008

Related U.S. Application Data
(63) Continuation of application No. 09/524,091, filed on Mar. 13, 2000.

(51) Int. Cl. H04N 7/025

(52) U.S. Cl. 725/36

(57) ABSTRACT

Aspects for providing tunable parameters to control distribution in a digital media distributor system are described. A digital media distributor (DMD) with tunable control of digital media data transmission aspect includes a distribution network, a central site system, and a plurality of remote site systems. The central site system utilizes a plurality of designated control parameters, including uplink parameters, scheduler parameters, and storage parameters, for controlling distribution of digital media data. The plurality of remote site servers receive digital media data transmissions from the central site server via the distribution network according to the designated control parameters.

### CROSS-REFERENCE TO RELATED APPLICATIONS

Under 35 USC § 120, this application is a continuation application and claims the benefit of priority to U.S. patent application Ser. No. 09/524,091, filed Mar. 13, 2000, entitled “Method for Providing Tunable Parameters to Control Distribution In A Digital Media Distributor”, all of which is incorporated herein by reference.

The present invention is related to co-pending U.S. Application, entitled MULTIMEDIA INFORMATION COMPUTER SYSTEM AND METHOD OF OPERATION OF A PLAYLIST SCHEDULER, Ser. No. 09/420,802, filed on Oct. 19, 1999, and assigned to the assignee of the present invention.

### FIELD OF THE INVENTION

The present invention relates to control parameters for tuning distribution in a digital media distributor in a multimedia broadcast system.

### BACKGROUND OF THE INVENTION

Although broadcasters have sophisticated systems for inserting national commercials into a program stream, including integrated traffic and billing systems, there are numerous obstacles to implementing a system to insert local commercials at small markets into a national program feed distributed by satellite. Until now, such local spot insertion advertising was the responsibility of the local broadcaster or cable operator.

Inserting local advertising poses several, nontrivial technical, logistical and business challenges. First, literally hundreds of widely distributed local operators (or affiliates) would need to receive the commercials; ad agencies would have to ship analog tapes to hundreds of organizations, with different traffic and billing systems. These tapes would need to be tested for quality assurance, tracked, and stored until needed. They would then have to be distributed to video tape recorders and readied for computer controlled playout (analog) at the proper time, 24 hours a day, seven days a week. Such infrastructure generally exists at well-funded affiliates in major markets but is nonexistent and prohibitively expensive for smaller operators or affiliates in small markets.

Managing such tapes with ads for local commercials and inserting them properly into the program feed is a complex undertaking not well-suited for the smaller operators, especially for channels with smaller audiences in smaller markets. A quality broadcast involves more than excellent program material; it must provide seamless insertion of national and local advertisements, promotions, and station identifications. Equally important is the ability to maintain the integrity of the national television programming. Centralized control of the channel's programming (playout) is required to prevent local affiliates from tampering with the programming.

A need exists for an efficient system for distributing digital media data, including tuning distribution by a digital media distributor via control parameters. The present invention addresses such a need.

### SUMMARY OF THE INVENTION

The present invention provides aspects of providing tunable parameters to control distribution in a digital media distributor system. A digital media distributor (DMD) with tunable control of digital media data transmission aspect includes a distribution network, a central site system, and a plurality of remote site systems. The central site system utilizes a plurality of designated control parameters, including uplink parameters, scheduler parameters, and storage parameters, for controlling distribution of digital media data. The plurality of remote site servers receive digital media data transmissions from the central site server via the distribution network according to the designated control parameters.

Through the present invention, a plurality of control parameters are provided that allow tuning of distribution in a DMD according to particular transmission needs. The use of the control parameters enhances the flexibility of achieving optimal management of transmissions from a central site to remote sites. More particularly, data storage, scheduling, and uplink components are tuned through the control parameters. These and other advantages of the aspects of the present invention will be more fully understood in conjunction with following detailed description and accompanying drawings.

### BRIEF DESCRIPTION OF THE DRAWINGS

FIG. 1 illustrates a block diagram of a digital media distribution system in accordance with the present invention.

FIG. 2 illustrates an example of a suitable layered architecture for the central site server.

FIG. 3 illustrates a block diagram of the DMD system, including tunable control parameters in accordance with the present invention.

### DETAILED DESCRIPTION

The present invention relates to tuning distribution in a digital media distributor through the use of control parameter values. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In accordance with the present invention, tunable parameters provide control in a digital media distributor (DMD) that provides a complete end-to-end system that gives local cable or network affiliates the ability to provide local ads and announcement insertion together with the delivery of cable or network feed(s). In general, the DMD integrates the entire process of sales, traffic, digital encoding and storage of spots, transmission of data, local insertion of digital ads and announcements, account reconciliation, and billing. Spots (i.e., media such as commercials, station identification, public service announcements, etc.) are digitized by the cable or network operator, and then digitally transmitted to the local cable head-ends or network affiliates from a central site. These digital spots are then stored on the remote site servers located at each head-end or affiliate.

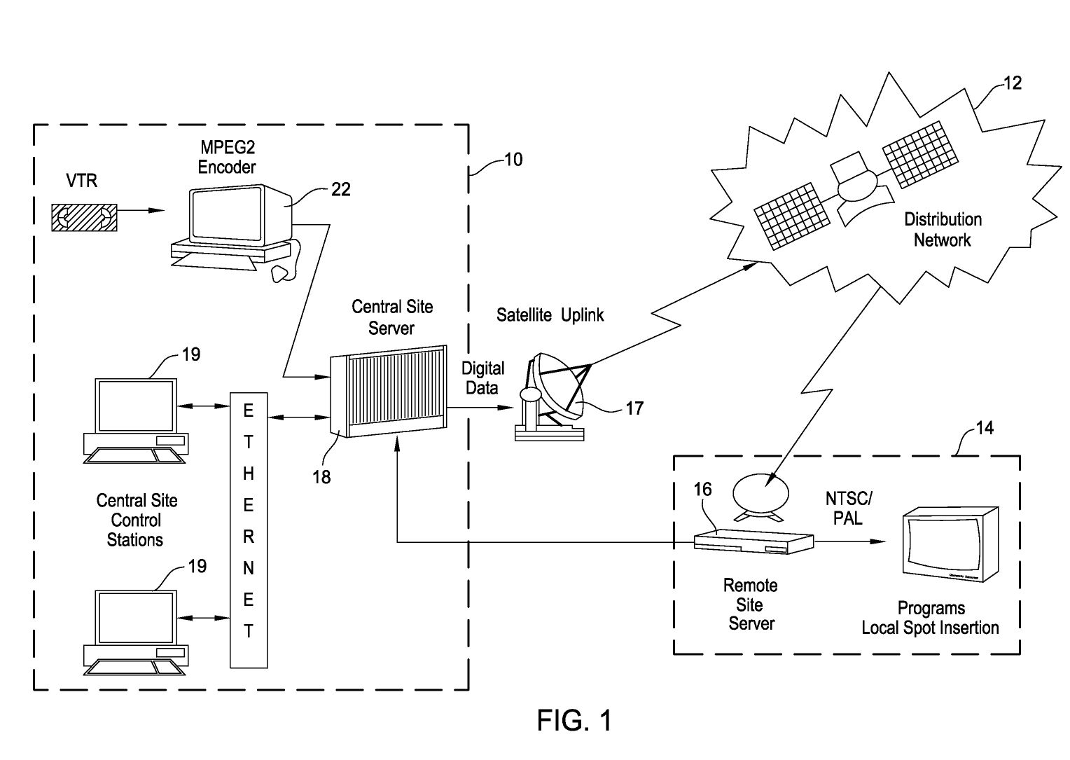

A block diagram of a DMD in accordance with the present invention is illustrated in FIG. 1. As shown, the DMD includes three major components: a central site 10, a distribution network 12, and a remote site 14. The central site 10 is the location for the digital encoding of MPEG-2 files from source video tapes, storage and management of digital files, management of remote site(s) 14, and distribution of schedules and MPEG-2 files. Thus, the processing, analysis, distribution, and management of data occurs at the central site 10. The distribution network 12 is the mechanism by which the remote site(s) 14 receive program streams and digital spots. The data distribution is accomplished via various methods, such as a satellite and/or land-based distribution. The broadcaster may choose to have the program stream sent via terrestrial links (e.g., token ring, ethernet, etc.), while the spot insertion is sent via satellites or vice versa.

The remote site(s) 14 house the remote site server(s) 16. By way of example, a suitable remote site server 16 includes a Pentium processor-based device with a hard disk for local storage and a video switch card (to switch between program and commercial insertion) running software including Windows NT, DMD programming, Lotus Notes client, Program Loader, and Symantec pcANYWHERE. These unattended, computerized systems receive the local insertion and provide As-Run file generation. The remote site server 16 is a video server that receives and stores digitized spots utilized for local insertion at the cable head-end. The remote site server 16 receives digitally encoded ads via satellite or other distribution network. These spots are decoded to an analog signal and inserted into the cable or network operator feed at scheduled times, i.e., into scheduled local availability times. The remote site server 16 can be customized in various configurations based on the number of output channels required, the type of output format (e.g., NTSC, PAL), the amount of local storage required (i.e., the number of spots on disk), the type of network (satellite or terrestrial), the type of trigger for spot insertion (e.g., time of day, VITC, cue-tome, VBI trigger), the audio format and connections (stereo, mini-XLR or XLR), the redundancy requirements (RAID, mirrored disks), and the preview channel.

By way of example, the following provides a sample process that illustrates an example of one process which the DMD solution can support. A region, e.g., any grouping of one ore many cable head-ends for cities, states, provinces, or countries, defined by cable or network operators in an area, sells a commercial in the local availability time. All remote site servers 16 within the same region play the same material at the same time, including all network programs, national spots, local commercials, announcements, etc. The videotaped segment for the commercial is digitally encoded. The digital material is scheduled for delivery to each remote site server 16 prior to broadcast. The playlist, digitized spots, and the broadcast program stream are sent, via satellite, to all of the remote site servers 16 within the region. All of the remote site servers 16 within the region air the local spots for that region at the scheduled time. As-Run logs are retrieved by the central site 10 from the remote site servers 16. As-Run logs are sent to the local markets, reviewed, reconciled, and customers are billed. Commercials and As-Run logs are archived.

In accordance with the present invention, the central site 10 efficiently distributes objects and thus manages the resources of the remote site 14. By managing these resources, the central site 10 can determine when to send information to the remote site(s) 14. A main component in producing the management of the resources is the central site server 18. By way of example, a suitable central site server 18 includes an IBM RS/6000 F50 dual CPU system, or a Pentium II compatible PC, running the IBM UNIX operating system, AIX, DB2 server software, Lotus Notes server software, ADSM, Windows NT (for PC-based central site server), and the DMD programming. Suitable components for the control workstations 19 include Pentium compatible PCs running Windows NT, Lotus Notes client, DB2 client, Microsoft Internet Explorer, and DMD programming.

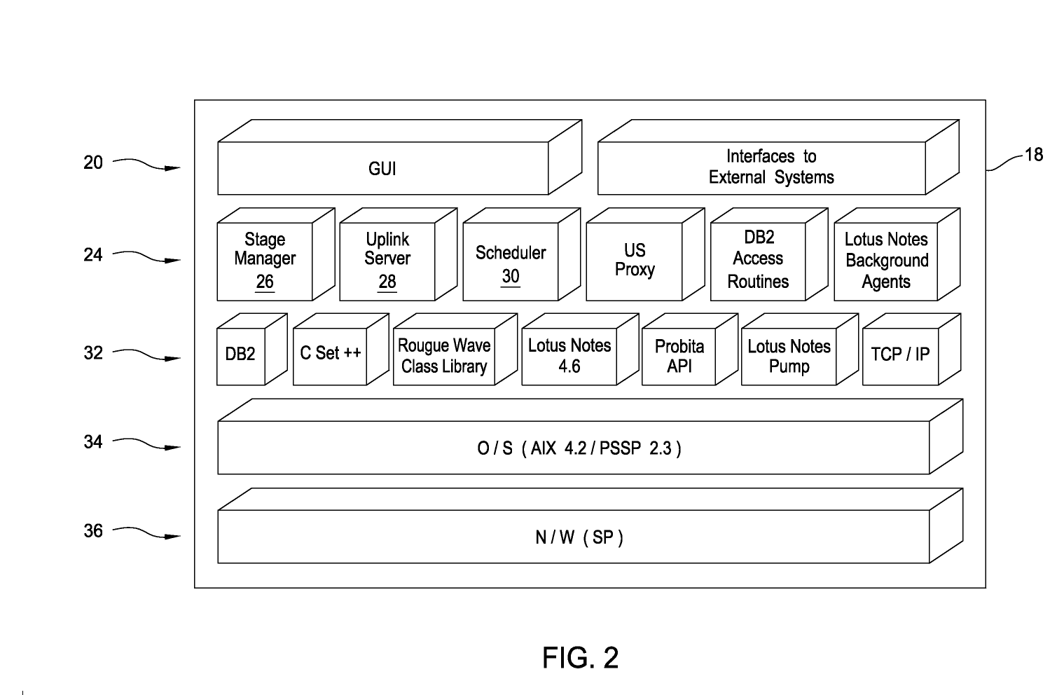

The central site server 18 includes software on a suitable computer readable medium that is architected using a layered model, in which each layer isolates the upper layers from the details of the lower layers and individual components within a layer provide a unique set of services, as is well appreciated by those skilled in the art. FIG. 2 illustrates an example of a suitable layered architecture for the central site server 18. The top layer 20 addresses the external interfaces of the central site server 18, including a graphical user interface (GUI) component and the interfaces to the external systems. The GUI component, e.g., using Lotus Notes, provides administrators and operators with the ability to monitor and control the DMD. The interfaces to external systems include interfaces to traffic systems, which interface to the central site 18 by way of files exchanged on an Internet file server, for example, interfaces to stations in a box (SIBs) which send Lotus Notes messages, and interfaces to encoder systems (22, FIG. 1), which store encoded spot files in a disk pool server for retrieval by the central site server 18.

Underneath the top layer is a layer 24 of specialized components including a stage manager component 26, an uplink server component 28, and a transmission scheduler component 30. This layer 24 may also include specialized components for creating commands and interpreting responses from SIBs, managing access to all the database queues and other data stores, and providing automated agents that run based on time or events to manage the external interfaces, e.g., processing files received from traffic systems. The stage manager 26 manages any tape related activity, the uplink server 28 manages transmissions through the uplink network (12, FIG. 1), and the transmission scheduler 30 manages scheduling tasks. Also included as a next layer is a programming layer 32. The layer 32 includes the programming libraries and APIs (application programming interfaces) that are used to build the specialized components. The lower two layers include an operating system layer 34 and a hardware layer 36 for the fundamental operation of the central site server 18, as is well appreciated by those skilled in the art.

The transmission scheduler 30 of layer 24 is responsible for managing transmissions from the central site 10 to the remote site server(s) 16. The transmission scheduler manages the transmission by executing a plurality of transforms (i.e., bodies of logic that take particular inputs and perform certain operations to produce particular outputs) and utilizing a plurality of queues, as described in co-pending U.S. patent application entitled METHOD AND SYSTEM FOR OPTIMIZATION OF DISTRIBUTION TO REDUCE STORAGE REQUIREMENTS IN A DIGITAL MEDIA DISTRIBUTOR, Ser. No. unknown (docket no. BC999063/1498P), assigned to the assignee of the present invention, and incorporated herein by reference in its entirety.

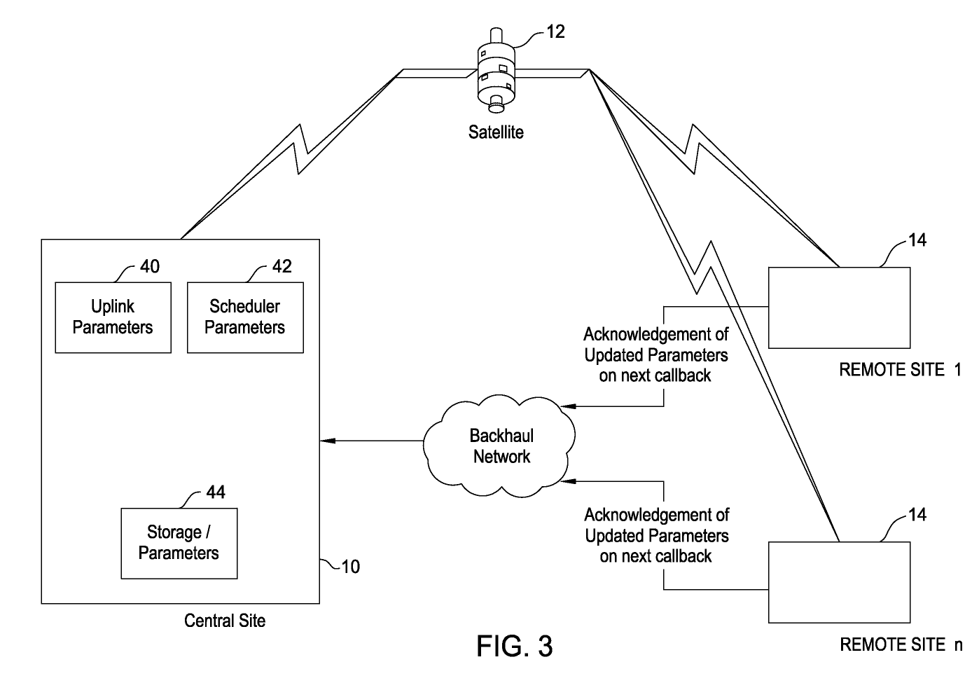

In accordance with the present invention, increased control of transmission in the DMD is achieved through the use of tunable control parameters. FIG. 3 illustrates a block diagram of the DMD system, including tunable control parameters represented by blocks 40, 42, and 44. The access and adjustment of the control parameters occurs via the control site 10, e.g., through an appropriate GUI input mechanism. Once set/updated, the parameters are sent to remote site(s) 14 via command/registry files over the distribution network 12. The tunable control parameters are broadly categorized as uplink parameters 40, scheduler parameters 42, and storage parameters 44, as shown. More particular examples of the parameters relate to transmission limits, retention limits, value limits, and time window limits, as described hereinbelow. Note, the following parameter names and values are meant as illustrative, with the parenthetical data representing minimum/default/maximum values.

Playlist retention period (1/7/14): a storage parameter related to a retention limit for designating the number of days that a playlist is kept past the original creation date

Playlist entries (1/280/2880): a storage parameter related to a value limit for designating the maximum number of entries in a single playlist Purgelist retention (1/7/14): a storage parameter related to a retention limit for designating the number of days that a purgelist is kept past the original creation date

Purgelist entries (1/720/720): a storage parameter related to a value limit for designating the maximum number of entries in a single purgelist DOA retention period (1/7/30): a storage parameter related to a retention limit for specifying the number of days records are kept in the uplink queue and dead on arrival (DOA) tables

Transmission lookahead window (3/6/9): a scheduler parameter related to a time window limit for scheduling the number of hours before a spot is next scheduled to be played at an SIB that each spot is to be transmitted to each SIB

Staging lookahead window (20/20/40): a scheduler parameter related to a time window limit for scheduling the number of hours before the time at which the spot is next scheduled that the spot is staged on the central site hard disk public area

SIB playtime lookahead window (4/5/8): a scheduler parameter related to a time window limit for indicating the number of hours within a playtime of a spot that an SIB checks to report a spot missing; these are spots scheduled to be played but which are not currently at the SIB

SIB spot disk high water mark (80/90/90): a scheduler parameter related to a value limit for indicating a percentage of used space on the SIB spot disk that, when equaled or exceeded, results in the SIB purge algorithm being invoked to free up space by deleting spots according to a chosen criteria (e.g., “least likely to be used”); expressed as a percentage of the total space available for spots

SIB spot disk low water mark (60/80/85): a scheduler parameter related to a value limit for indicating a percentage of space on the SIB spot disk that, when equaled or gone below, results in the stopping of the SIB purge algorithm

Searchable length of transmit queue (60/60/120): a scheduler parameter related to a transmission limit for indicating how far back in terms of minutes that the transmission scheduler should search for items in the queue to be made into a bundle for the uplink server

Searchable length of the staging queue (4/4/12): a scheduler parameter related to a transmission limit for indicating how far back in terms of hours that the transmission scheduler should search for items in the queue to be made into a bundle for the stage manager; preferably, should be same length as the searchable length of the transmit queue

Playlist transmission lookahead (24/48/72): a scheduler parameter related to a time window limit for determining how many hours in advance playlists are transmitted to the SIBs

Minimum transit time (1/5/60): a scheduler parameter related to a transmission limit for indicating the minimum time in terms of minutes that is a minimum total time in which a spot can be transmitted to a SIB; If the life (i.e., time until a next scheduled play time) of a scheduled item is less than the minimum transit time when the spot reaches the head of the transmit queue, the spot is taken to be dead, because it cannot be transmitted in time.

SIB reporting timeout limit (1/5/60): a scheduler parameter related to a transmission limit for indicating a time in terms of minutes that the central site considers that a SIB callback is late (i.e., if the SIB does not callback within the selected number of minutes of the expected time)

History retention period (1/7/14): a scheduler parameter related to a retention limit for specifying the number of days records are kept in status logs

Schedule look-ahead (1/1/5): a scheduler parameter related to a time window limit for specifying the number of days of playlists that the transmission scheduler will attempt to process at a time

Maximum request deletion (1000/2000/5000): a scheduler parameter related to a value limit for specifying a maximum number of requests to be deleted at one time from the request queue when the requests reach the end of the retention period

Missing spot resend period (0.5/2/24): a scheduler parameter related to a transmission limit for specifying a resend period for missing spots where the missing spot was sent longer than the value specified and the current spot status is waiting for reconciliation in the uplink queue; preferably set at a value which is twice the callback interval

Non-spot retransmission limit (0/8/23): a scheduler parameter related to a transmission limit for specifying the number of retransmits allowed for non-spot files

Non-spot retransmission period (1/10/24): a scheduler parameter related to a transmission limit for specifying a duration in hours of a retransmission period for non-spot files

Request queue retention period (1/36/36): a scheduler parameter related to a retention limit for specifying the number of hours a record is kept in the request queue

Scheduler retention period (2/2/7): a scheduler parameter related to a retention limit for specifying the number of days that the system will keep past playlists and NLBSs (National Local Break Schedule)

Scheduler retransmission limit (0/3/5): a scheduler parameter related to a transmission limit for specifying the number of retransmissions

Scheduler retransmission period (1/4/6): a scheduler parameter related to a transmission limit for specifying the duration in hours of the retransmission period for spot files

Stage manager record expiration (0.5/0.5/1): a scheduler parameter related to a time window limit for indicating that the stage manager records will be marked expired if the air date time is sooner than the current time plus the specified offset time (in hours)

Stage manager queue retention period (1/24/24): a scheduler parameter related to a retention limit for specifying the number of hours records are kept in the stage manager queue

Spot unavailable warning (24/24/36): a scheduler parameter related to a transmission limit for specifying the number of hours prior to a scheduled air time that a spot must be on a server to avoid generating a spot not available warning message

Uplink expiration (0.5/0.5/1): a scheduler parameter related to a transmission limit for specifying an offset time in hours that is used to determine if there is not enough time to uplink a file

Uplink queue retention period (3/24/24): a scheduler parameter related to a retention limit for specifying a number of hours that records are kept in the uplink queue

Stage manager archive threshold (0/10/40): a scheduler parameter related to a time window limit for specifying the time in hours within the stage manager look-ahead to highlight de-archived spots

Stage manager look forward (4/4/12): a scheduler parameter related to a time window limit for specifying look forward time duration for the stage manager queue table

Stage manager look-ahead (20/20/40): a scheduler parameter related to a time window limit for specifying a look-ahead time in hours to retrieve the stage manager queue table; this value and the stage manager look forward are added to the current time to determine which spots should be staged for transmission

Uplink request window (0/0/1): uplink parameter related to a time window limit for specifying a minimum window size in hours for retrieval of a next request by the uplink server

Uplink broadcast interval (0.5/0.5/2): uplink parameter related to a transmission limit for specifying time interval in seconds between successive repeats of broadcast messages, schedules, and command files

Uplink broadcast transmissions (1/3/5): uplink parameter related to a value limit for specifying the number of successive repeats of broadcast messages, schedules, and command files

Uplink forward (1/1/3): uplink parameter related to a time window limit for specifying duration in hours for the uplink component to transmit files

Uplink look-ahead (6/6/12): uplink parameter related to a time window limit for specifying look-ahead period in hours for the uplink component to start transmitting files

Through the present invention, a plurality of control parameters are provided that allow tuning of distribution in a DMD according to particular transmission needs. The use of the control parameters enhances the flexibility of achieving optimal management of transmissions from a central site to remote sites. More particularly, data storage, scheduling, and uplink components are tuned through the control parameters.

Although the present invention has been described in accordance with the embodiments shown, one of ordinary skill in the art will readily recognize that there could be variations to the embodiments and those variations would be within the spirit and scope of the present invention. For example, although particular control parameters have been described, these are meant as illustrative and not restrictive of the control parameters capable of use to tune distribution in a DMD. Accordingly, many modifications may be made by one or ordinary skill in the art without departing from the spirit and scope of the appended claims.

What is claimed is:

1. A system for controlling insertion of a plurality of local spots into a program feed, the system comprising:
a central site server located at a central control site; and
one or more remote site servers located at one or more corresponding remote sites relative to the central control site,
the central site server distributing the plurality of local spots, prior to playout of the program feed, from the central site server to the one or more remote site servers,
the central site server sending a plurality of control parameters from the central site server to each of the one or more remote site servers, the plurality of control parameters including one or more parameters specifying requirements for availability of the local spots on the central site server to the one or more remote servers to allow playout of the local spots,
the central site server transmitting the program feed from the central site server to each of the one or more remote site servers,
each of the remote site servers automatically switching between playout of the program feed and playout of each local spot in accordance with the plurality of control parameters received from the central site server located at the central control site, and
the control parameters including a playtime lookahead window parameter that sets a time period requirement before the scheduled playout of a local spot at which time each of the remote site servers checks to report to the central server a local spot missing at the remote site server.

2. The system of claim 1, wherein:
the program feed comprises one of a cable feed or a network feed; and
each local spot comprises one of local advertising or a local announcement.

3. The system of claim 2, wherein the central site server is in communication with each of the remote site servers through a plurality of types of distribution network links, wherein the program feed is transmitted via one type of network link, and the local spots are distributed via a different type of network link.

4. The system of claim 3, wherein one of the types of network links is a terrestrial link and the other of the types of network links is a satellite link.

5. The system of claim 2, wherein sending a plurality of control parameters includes sending uplink parameters, scheduler parameters, and storage parameters for controlling distribution of the program feed and the plurality of local spots from the central site server to each of the one or more remote site servers through the distribution network.

6. The system of claim 5, wherein:
the uplink parameters include one or more of an uplink broadcast transmission, an uplink forward, or an uplink look-ahead;
the scheduler parameters include one or more of a transmission lookahead window, a staging lookahead window, a station in a box (SIB) playtime lookahead window, an SIB spot high water mark, an SIB spot low water mark, a searchable length of transmit queue, a searchable length of a staging queue, a playlist transmission lookahead, a minimum transmit time, an SIB timeout limit, a history retention period; and
the storage parameters include one or more of playlist entries, purgelist entries, a playlist retention period, a purgelist retention, a dead on arrival (DOA) retention period.

7. The system of claim 1 wherein the control parameters include a staging lookahead window parameter that sets a time period requirement prior to a scheduled playout of each of the local spots at which time the local spot must be staged on the central site server for reception by the one or more remote site servers.

8. The system of claim 1 wherein the control parameters include a minimum transit time parameter that indicates a minimum transit time needed to transmit a particular one of the local spots to one or more remote site servers, such that when the remote site servers determine that a time until a next scheduled playout of the particular local spot is less than the minimum transit time, the local spot is considered to be dead.

9. A computer program product tangibly stored on a computer readable medium for controlling insertion of a plurality of local spots into a program feed through a central site server located at a central control site, the product comprising instructions to cause a programmable processor to:
prior to playout of the program feed, distribute the plurality of local spots from the central site server to one or more remote site servers located at one or more corresponding remote sites relative to the central control site;
send a plurality of control parameters from the central site server to each of the one or more remote site servers, the plurality of control parameters including one or more parameters specifying requirements for availability of the local spots on the central site server to the one or more remote servers to allow playout of the local spots; and
transmit the program feed from the central site server to each of the one or more remote site servers,
wherein the product further comprises instructions for each of the remote site servers to automatically switch between playout of the program feed and playout of each local spot in accordance with the plurality of control parameters received from the central site server located at the central control site,
wherein the control parameters include a playtime lookahead window parameter that sets a time period requirement before the scheduled playout of a local spot at which time each of the remote site servers checks to report to the central server a local spot missing at the remote site server.

10. The computer program product of claim 9, wherein:
the program feed comprises one of a cable feed or a network feed; and
each local spot comprises one of local advertising or a local announcement.

11. The computer program product of claim 10, wherein the central site server is in communication with each of the remote site servers through a plurality of types of distribution network links, and wherein the program feed is transmitted via one type of network link, and the local spots are distributed via a different type of network link.

12. The computer program product of claim 11, wherein one of the types of network links is a terrestrial link and the other of the types of network links is a satellite link.

13. The computer program product of claim 10, wherein the instructions to send a plurality of control parameters include instructions to send uplink parameters, scheduler parameters, and storage parameters for controlling distribution of the program feed and the plurality of local spots from the central site server to each of the one or more remote site servers through the distribution network.

14. The computer program product of claim 9 wherein the control parameters include a staging lookahead window parameter that sets a time period requirement prior to a scheduled playout of each of the local spots at which time the local spot must be staged on the central site server for reception by the one or more remote site servers.

15. The computer program product of claim 9 wherein the control parameters include a playtime lookahead window parameter that sets a time period requirement before the scheduled playout of a local spot at which time each of the remote site servers checks to report to the central server a spot missing at the remote site server.

16. A digital media distributor (DMD) for controlling insertion of a plurality of local spots into a program feed, the digital media distributor (DMD) comprising:
a central site server located at a central control site to distribute the plurality of local spots to one or more remote site servers located at one or more corresponding remote sites relative to the central control site, the plurality of local spots being transmitted from the central site server prior to playout of the program feed, the central site server to further send a plurality of control parameters to each of the one or more remote site servers and transmit the program feed to each of the one or more remote site servers, the plurality of control parameters including one or more parameters specifying requirements for availability of the local spots on the central site server to the one or more remote servers to allow playout of the local spots; and
one or more of the remote site servers, each of the remote site servers to automatically switch between playout of the program feed and playout of each local spot in accordance with the plurality of control parameters received from the central site server located at the central control site,
the control parameters including a playtime lookahead window parameter that sets a time period requirement before the scheduled playout of a local spot at which time each of the remote site servers checks to report to the central server a local spot missing at the remote site server.

17. The digital media distributor (DMD) of claim 16, wherein:
the program feed comprises one of a cable feed or a network feed; and
each local spot comprises one of local advertising or a local announcement.

18. The digital media distributor (DMD) of claim 17, further comprising a plurality of types of distribution network links through which the central site server is in communication with each of the remote site servers, and wherein the program feed is transmitted via one type of network link, and the local spots are distributed via a different type of network link.

19. The digital media distributor (DMD) of claim 18, wherein the plurality of control parameters includes uplink parameters, scheduler parameters, and storage parameters for controlling distribution of the program feed and the plurality of local spots from the central site server to each of the one or more remote site servers through the distribution network, and wherein the control parameters include a time window limit parameter that sets a time period requirement prior to a scheduled playout of each of the local spots at which time the local spot must be staged on the central site server for reception by the one or more remote site servers.
